(19) United States
(12) Patent Application Publication
(10) Pub. No.: US 2024/0270032 A1
(43) Pub. Date: Aug. 15, 2024

(54) METHOD FOR ASCERTAINING THE LOAD APPLIED TO A PNEUMATIC TIRE WHILE ROLLING

(71) Applicant: COMPAGNIE GENERALE DES ETABLISSEMENTS MICHELIN, Clermont-Ferrand (FR)

(72) Inventors: SIMON NUYTTEN, Clermont-Ferrand (FR); DENIS ALFF, Clermont-Ferrand (FR); DENIS MARTIN, Clermont-Ferrand (FR)

(21) Appl. No.: 18/681,574

(22) PCT Filed: Aug. 1, 2022
(86) PCT No.: PCT/FR2022/051540

§ 371 Date: Feb. 6, 2024

(30) Foreign Application Priority Data
Aug. 6, 2021 (FR) FR2108547

(51) Int. Cl. B60C 23/06; G01G 19/08

(52) U.S. Cl. CPC B60C 23/064; G01G 19/08

(57) ABSTRACT

Ascertaining the load applied to a pneumatic tyre, comprising the following steps:
Fastening a sensor to the tyre so as to generate an acceleration along the normal to the crown;
Acquiring (201) a temporal signal Sig^{TDR} (101) comprising the amplitude of the acceleration while rolling;
Determining a speed W^{reference} (202) associated with a portion of the signal Sig^{TDR};
Normalizing (203) the portion of the signal Sig^{TDR} by a variable which is a function F proportional to the square of W^{reference}.
Angularly resampling (204) the portion of the signal Sig^{TDR};
Defining (205) an energy density S, by means of a threshold A or a spectral variable B, by spectral analysis, from the resampled normalized signal Sig^{TDR};
Identifying (206) the deformation Def % as a function G of S or of β;
Identifying (207) the load Z by the function H of Def %.

### FIELD OF THE INVENTION

The present invention concerns the field of measurement signals supplied by measurement means mounted on the mounted assembly of a terrestrial vehicle while rolling in order to determine the static load applied to the mounted assembly.

### Technological Background

Recent developments in connected mounted assemblies, measuring physical variables of the mounted assembly by means of on-board sensors in the mounted assembly, lead to determination of the state of the mounted assembly and hence open the door for the development of services linked to monitoring the state of the mounted assembly. Although general variables measured, such as the inflation pressure of the mounted assembly or the temperature of this mounted assembly, are not very sensitive to measurement noise generated by rotation of the mounted assembly on a surface of random roughness since these general variables vary only slightly during rotation of the mounted assembly, finer variables are highly sensitive to physical phenomena linked to the rotation of the mounted assembly. Furthermore, the mounted assembly is subjected to external forces such as the static load or inflation pressure. Other forces apply at any instant, and in particular while static, such as load. These applied forces may affect the fine variables to be measured. Finally, new services require cleaning of the physical variables directly measured before obtaining useful information from measurement signals, such as the static load on the tyre casing.

One of the objects of the invention below is to solve the problems of disruption of measurement signals generated by a sensor so as to obtain only a measurement cleaned of disruption of certain physical phenomena, with the aim of obtaining a scalar value, for the static load on the tyre casing.

In order to gain a better understanding of the invention, the circumferential direction S, axial direction A and radial direction R are directions defined with respect to the rotating frame of reference of the tyre casing about its natural axis of rotation. The radial direction R is the direction extending perpendicularly away from the natural axis of rotation. The axial direction A is the direction parallel to the natural axis of rotation. Finally, the circumferential direction S forms a direct trihedron with the predefined radial and axial directions.

### DESCRIPTION OF THE INVENTION

The invention concerns a method of ascertaining the load applied to a tyre casing. The tyre casing is mounted on a wheel so as to constitute a mounted assembly in rolling state with rotation speed W. The tyre casing has a crown in contact with the ground and in revolution about a natural axis of rotation. The method comprises the following steps:
Fastening at least one sensor to the tyre casing at the crown of the tyre casing so as to generate at least one output signal sensitive to the acceleration, in the direction normal to the crown, applied to said sensor in the tyre casing;
Acquiring at least one first temporal signal Sig comprising at least the amplitude of the at least one output signal while rolling;
Delimiting the first signal over a number N^{TDR} of wheel turns, N^{TDR} being greater than or equal to 1, so as to construct a wheel-turn signal Sig^{TDR},
Determining at least one reference speed W^{reference} associated with at least one portion of the wheel-turn signal Sig^{TDR},
Normalizing the at least one portion of the wheel-turn signal Sig^{TDR} by a variable which is a function F proportional to the square of the reference speed W^{reference} over a number of wheel turns N^{TDR}, wherein N^{TDR} is greater than or equal to 1;
Angularly resampling the at least one portion of the wheel-turn signal Sig^{TDR};
Defining at least one first energy density S from the at least one angularly resampled normalized wheel-turn signal Sig^{TDR}, by means of a threshold A or, if the angular pitch is fixed, at least one spectral variable from the spectral signal spect(Sig) of the at least one portion of the angularly resampled normalized wheel-turn signal Sig^{TDR};
Identifying the deformation Def % of the tyre casing as a function G of the at least one first energy density S or the at least one spectral variable;
Defining the load Z applied to the mounted assembly by means of a bijective function H comprising at least, as a variable, the deformation Def % of the tyre casing.

The signal recovered from the sensor is the temporal amplitude of the acceleration of the sensor during rolling of the mounted assembly under the specified conditions in the direction normal to the crown. Thus the acquired signal displays the variations in amplitude over a portion of the wheel turn for the tyre casing, including potentially those associated with the crossing of the contact patch by the portion of the tyre casing where the sensor is mounted, but also those associated with other specific zones of the wheel turn, such as that corresponding to the angular sector opposite the contact patch which is susceptible to counter-deflection, or those corresponding to angular sectors situated at 90 degrees from the contact patch relative to the axis of rotation. In all these zones, variations in movement of the accelerometric type sensor can potentially be observed on the output signal depending on the sensitivity of the sensor.

This first acquired signal is associated with a reference speed which can be identified on this first signal or result from another source such as another signal, or the output of a variable by a system external to the mounted assembly. This reference speed is necessarily associated with the same time frame as the portion of the first signal. This reference speed serves to normalize the amplitude of the first signal using a function F, the variable of which is the reference speed. The function F is the power function squared. The sensor signal is normalized as a function of the dependency of the amplitude of the sensor signal on the reference speed, if this dependency is perceived as a parasitic signal of the tyre casing deformation. Thus the first normalized signal becomes independent of this reference speed. For example, this reference speed may be the rotation speed of the mounted assembly, or the translation speed of the mounted assembly in the direction of movement of the mounted assembly. Therefore the first signal may be used independently of the reference speed, which is linked to the rotation of the mounted assembly.

The method also comprises a step of delimiting the first signal Sig over a number of wheel turns with the aim of using the periodicity of the sensor signal to the natural rotation of the tyre casing in rolling condition. However, for this step it is not essential that the number of wheel turns is integral, and the signal may be delimited over an actual number of wheel turns, as long as this number of wheel turns is at least greater than 1. Preferably, several wheel turns are used.

The method also comprises an angular resampling of the first signal or the wheel-turn signal, which may take place before or after the step of normalization. This step allows the temporal signal to be transformed into a spatial signal by phasing the temporal signal relative to one or more angular references of the mounted assembly. This angular reference may firstly be taken from the first signal by a particular response of the sensor to an individual azimuth on the wheel turn. However, this angular reference may also be taken from another signal of a sensor which shares a common timer with the first signal. This shared timer or synchronization of signals is natural if the two sensors are taken from the same device or if the signals are transmitted to a common device. This angular resampling naturally allows generation of a spatial signal periodic to the wheel turn. For this, to generate a perfectly angularly periodic signal, it is sufficient to interpolate the signals over a set angular division. But if the mounted assembly is subject to movement at variable speed, this resampling still allows generation of an angularly periodic signal. It is not essential for the method that the angular resampling generates an output signal with a fixed angular pitch.

In the first alternative, simply comparing the level of amplitude of the wheel-turn signal with a threshold A allows definition of an energy density S. The amplitude of the wheel-turn signal relative to a threshold value A, which may for example simply be the unit value, potentially generates a component of a doublet of deformation energy densities, one positive and one negative (S+, S−), from the wheel-turn signal. Thus, the method merely defines a tyre casing deformation energy density and allocates it between two subsets according to its position in relation to the threshold value A. These are operations that are simple to perform and consume little by way of resources.

In the second alternative, the method comprises a step of performing a spectral analysis from the portion of the angularly resampled normalized wheel-turn signal. It is useful here to ensure that the portion of the initial signal is defined by a constant angular pitch, which ensures regular spatial discretization of the sensor signal. As required, the step of angular resampling ensures that the angular pitch is fixed, allowing a spectral analysis of quality, which may require a method of interpolation of measurement points in order to redefine a signal with fixed angular pitch. The method then comprises a step of defining a spectral variable or several spectral variables associated with the spectral signal resulting from the preceding step.

Whichever alternative is used, the method determines the tyre casing deformation as a function of either the calculated energy density or the at least one spectral variable, Thus, in the first alternative, the deformation represents a deformation energy normalized over one physical wheel turn of the tyre casing. As a result, an energetic invariable connected with the tyre casing deformation subjected to a load in rolling condition is identified. In the second alternative, the deformation is expressed in the form of a scalar or vector which is an invariant of the tyre casing in rolling condition subjected to a static load.

Naturally, a single wheel turn is necessary to determine the tyre casing deformation Def . . . However, preferably, the number of wheel turns will be at least 5, or even 10, so that the results can be averaged, which will enable any unpredictable phenomena in the signal to be overcome, such as obstacles on the roadway over which the tyre casing is rolling. Thus, in an industrial mode, the precision of the method is thereby improved.

Finally, whatever alternative is selected, the method comprises a step of determining the static load Z applied to the mounted assembly using a function H dependant on the tyre casing deformation Def_{%}, which itself is expressed differently depending on the alternative selected. Therefore, since the the representation space of the tyre casing deformation Def_{%,} is different, the function H is linked to the choice of representation space of the tyre casing deformation Def_{%,} which is linked to the alternative selected.

Advantageously, the step of determining the reference speed W^{reference} consists of establishing the ratio of the angular variation to the temporal duration separating two azimuthal positions of the sensor in the tyre casing around the natural axis of rotation, from the wheel-turn signal Sig^{TDR} or from a signal in phase with the first signal Sig^{TDR} according to the following formula:

$${W}^{reference} = Δ ( α ) / Δ ( t ) \qquad [ Math 1 ]$$

wherein a is the angular position and t is the temporal abscissa associated with the angular position.

In the case where the reference speed corresponds to the angular rotation speed of the tyre casing, this reference speed is calculated over an angular variation of the signal between two known positions. Preferably, this reference speed is evaluated over a signal duration of less than one wheel turn, which allows rapid definition thereof and performance of the step of normalization of a portion of the first signal at the electronic device associated with the sensor. Moreover, this then allows angular resampling of the portion of the first signal with better precision if the tyre casing moves with a variable angular speed. In fact, at the level of a wheel turn, the variation in angular speed is necessarily small for a tyre with a development which may extend to 2 metres for a car tyre or 3 metres for a truck tyre. The acceleration or deceleration applied to the tyre casing over this length is naturally low with drive and braking systems of current vehicles. Naturally, it is quite possible to integrate a variation in angular speed during the wheel turn with a finer azimuth setting, so as to take account for example of micro-variations in angular speed which occur during the wheel turn, such as for example before and after passing through the contact patch or when encountering a discontinuity in movement over the ground, such as a transverse bar on the ground. This precision of reference speed during a wheel turn then allows a more precise normalization of the signal, but also an increased angular precision in the angular position of the measurement points of the first signal during the angular resampling step, which improves the precision desired for sensing minimal variations during the wheel turn.

According to a particular embodiment, the azimuthal positions of the tyre casing are included in the group comprising an angular position which can be detected from the wheel-turn signal Sig^{TDR}, corresponding to the entry into the contact patch, the exit from the contact patch, or the central position of the contact patch, or any defined angular position from the signal in phase with the wheel-turn signal Sig TDR

These are azimuthal positions which affect the signal from the acceleration sensor and correspond to specific angular positions. Therefore these positions are easy to identify on the signal from the sensor. Furthermore, it is easy to assign their azimuthal references. In fact the central position of the contact patch corresponds to an azimuthal position of 0 or 180 degrees relative to the normal to the ground. If a contact patch length is determined through the entry and exit points of the contact patch, the angle formed by the contact patch can be established as the ratio of the contact patch length to the development of the tyre casing over one wheel turn or 360 degrees. The sector formed by the contact patch on either side of the normal to the ground is evenly divided. Naturally, access to a signal other than the first signal also allows an angular sectorization which is finer than one wheel turn, as an angular encoder.

Advantageously, the angular pitch is less than 18 degrees.

It can thus be ensured that one of the measurement points is situated in the contact patch. Therefore resulting acceleration variations will be observed at least between this sampling point and the closest neighbouring points, allowing determination of entry and exit points of the contact patch in the first signal.

Highly advantageously, the angular pitch is less than 6 degrees, preferably less than 3 degrees.

Use of a finer angular pitch allows sensing of several measurement points in the contact patch. This fineness of observation allows better precision of the method by avoiding a spatial discretization of points, which is not necessarily regular here. The multitude of points also ensures no disruption due to incoherent measurement by the sensor.

According to a preferred embodiment, the method comprises the step of aggregating the data from the at least one portion of the angularly resampled normalized wheel-turn signal Sig^{TDR} over at least one sub-portion of the at least one portion of the angularly resampled normalized wheel-turn signal Sig^{TDR}, the sub-portion of the at least one portion of the normalized wheel-turn signal Sig^{TDR} becoming the at least one portion of the angularly resampled normalized wheel-turn signal Sig^{TDR}.

Preferably, the sub-portion of the at least one portion of the angularly resampled normalized wheel-turn signal Sig^{TDR} is an integral multiple of a wheel turn, highly preferably a single wheel turn.

This step allows identification of a wheel-turn signal taking into account variations in the wheel turn, which allows a reduction in the size of vectors to be handled for the final two steps of the method, namely that used to identify the first energy density S or the spectral variables following spectral analysis of the signal. To this end, the sub-portion of the angularly resampled normalized wheel-turn signal is an integral multiple of a single wheel turn, in order to benefit from the natural periodicity of the signal to the wheel turn. This periodicity is preferable for spectral analysis of the quality.

According to a preferred embodiment, the data aggregation step comprises one of the methods contained in the group comprising the mean over a decile interval, the median, the selection or interval of deciles, the methods of interpolation, the weighted or non-weighted mean, optimization of the parametric model of tyre deformation.

The purpose of aggregation is to set the measures performed over a new angular distribution of the first signal in order to make sense of the set of raw measurement data, while not prioritizing one zone over another because of an abundance of measurement points. The aggregation step is intended to supply a balanced signal in terms of measurement points with an angular pitch selected by the operator according to the tyre casing deformation to be observed. To this end, the method of optimizing the parametric model of the tyre deformation is ideal, since this parametric model may be theoretical, not taking into account measurement noise linked to the entire measurement chain applied. The output signal from the aggregation step is a theoretical output of the parametric model having minimal spread with the set of measurement points recorded.

Advantageously, having phased the first signal Sig with respect to an angular position of the tyre casing, a correction Corr is made to the first signal Sig to take account of the effect of terrestrial gravity before the normalization stage.

The drawback of the accelerometric signal is that it is sensitive to terrestrial gravity if oriented approximately parallel to terrestrial gravity. In the case of the tyre casing, the sensor is rotationally linked to the tyre casing. Therefore when the sensor is oriented radially, the amplitude of the sensor signal is influenced by terrestrial gravity during a wheel turn. This is reflected in the signal in the form of a sinusoidal function of amplitude linked to terrestrial gravity, with nodes at the azimuths of the tyre casing separated by 180 degrees when the orientation of the sensor is aligned with the gravitational vector, i.e. substantially perpendicular to the ground. Conversely, when the sensor is oriented parallel to the ground, which corresponds to two azimuthal positions separated from one another by 180 degrees and generally situated at approximately +/−90 degrees from the gravitational vector, the sensor signal is not influenced by terrestrial gravity. In order to eliminate this parasitic component of the accelerometric signal, the amplitude of the signal should be combined with a corresponding sinusoidal function, by having phased the first sensor signal with the vertical to the ground corresponding to the direction of the gravitational vector.

According to a particular embodiment, the method comprises a step of filtering the at least one portion of the angularly resampled normalized wheel-turn signal Sig^{TDR}.

High-frequency interference may remain on the angularly resampled normalized signal, which will be processed in the following step. For example, in the case of alternative one, the step for defining the energy density S using the threshold A, filtering the signal will simplify the step by minimizing possible errors.

According to a second preferred embodiment, the step of acquiring the at least one spectral variable from a spectral signal spect(Sig) of the at least one portion of the angularly resampled normalized wheel-turn signal Sig^{TDR} consists of identifying the at least one spectral variable over at least one spectral block of the spectral signal spect(Sig), preferably over the first positive spectral block of the spectral signal spect(Sig).

Preferably, the at least one identified spectral variable is contained in the group comprising the maximum value, the median value, the mean value, the pass-band of the first block, the area below the curve of the first block, the frequency of the median value, the frequency of the mean value, the frequency of the maximum value.

According to the first preferred embodiment, the step of acquiring the at least one energy density S from the at least one portion of the angularly resampled normalized wheel-turn signal Sig^{TDR} by means of a threshold A consists of defining a first energy density S⁺ when the at least one portion of the angularly resampled normalized wheel-turn signal Sig^{TDR} is greater than the threshold A, or defining a second energy density S-when the at least one portion of the angularly resampled normalized wheel-turn signal Sig^{TDR} is less than or equal to said threshold A.

As a preference, this ratio lies between 0.5 and 0.9.

The purpose of the threshold A is to distribute the discretized points of the angularly resampled normalized wheel-turn signal Sig^{TDR} between the energy densities S⁺ and S⁻. If the signal carries a lot of noise, as in the absence of the data aggregation step or the filtering step, this distribution of points may be influenced by this interference. The purpose of the threshold A is to correct this imperfection linked to the measuring signal. The value of threshold A is a function of the quality of the angularly resampled normalized wheel-turn signal Sig^{TDR}. If the method takes the optional steps and the roughness of the road is low, a value at the top of the range will be preferred.

Highly preferably, the definition of the positive S+ and negative S energy densities is obtained by the following formulae:

$${S}^{+} = ⌈ {\sum }_{{Sig}^{TDR} > A} ( {Sig}^{TDR} - 1 ) ⌉ * \frac{{N}^{′ TDR}}{{N}^{U}} ; and \qquad [ Math 2 a ]$$

$${S}^{-} = ⌈ {\sum }_{{Sig}^{TDR} \leq A} ( {Sig}^{TDR} - 1 ) ⌉ * \frac{{N}^{′ TDR}}{{N}^{U}} ; \qquad [ Math 2 b ]$$

wherein u is the abscissa value of the angularly resampled normalized wheel-turn signal Sig^{TDR}.

This is a simple way of obtaining a scalar value of each energy density from the discretized signal from the angularly resampled normalized wheel-turn signal using elementary mathematical and logical operations. These operations may take place in the electronic device linked to the sensor.

Advantageously, the function G is a linear function.

In the case of the first alternative, the function G is a linear function of the spectral density S according to the following formula:

$$G ( X ) = X / {N}^{′ TdR} \qquad [ Math 3 a ]$$

Thus this is an elementary formula for the tyre casing deformation which applies either to S⁺ or S⁻. Necessarily, S⁻ corresponds to the energy density calculated from material points of the development of the tyre which, at a precise moment in time T, include those in the contact patch or in the immediate vicinity thereof. Specifically, these points have an absolute acceleration close to zero when passing through the contact patch, and so they are necessarily below the threshold value A. By default, the energy density S⁺ corresponds to the energy density of the other points on the development of the tyre and notably those outside the contact patch. That demonstrates that there is an invariable connected with the tyre casing deformation subjected to a load Z. In instances in which it is only S⁺ that is used, there is no need to have a high spatial discretization because the variations outside of the contact patch are not as significant. The advantage of this is to reduce the necessary sampling frequency of the electronic device coupled to the sensor or to be able to obtain precise information on the tyre casing deformation at high rotational speeds.

However, function G is a linear function of the spectral densities S+ and S, according to the following formula:

$$G ( X , Y ) = ( X + Y ) / ( 2 * {N}^{′ TdR} ) \qquad [ Math 3 b ]$$

In that case, the tyre deformation energy needs to be summed around the entire development of the tyre. In order to be certain of minimizing measurement uncertainties, use is then made of the set of measurement points for measuring the acceleration normal to the crown in order to determine the tyre casing deformation, which makes it possible to reduce the energy consumption in comparison with an analysis employing a high frequency.

In the case of the first alternative, the applicant was surprised to find that study of the first positive frequency block of the spectral signal spect(Sig) was sufficient to identify one or more variables associated with this first block which are relevant for determining the tyre casing deformation with adequate quality. The variables most sensitive to tyre casing deformation are specified in the list provided. These are standard variables of a spectral signal requiring few calculation resources, which is favourable for the method. Furthermore, these variables are sensitive mainly to tyre casing deformation, and much less to secondary variables. Consequently, these variables are ideally suited for example to the general deformation of the tyre casing as a whole, such as deformation generated by global forces on the entire tyre casing, such as the static load.

In this case, function G need not be sophisticated; the applicant has found that a linear function G of one or more spectral variables allows suitable determination of the tyre casing deformation according to the various conditions of use of the tyre casing subjected to variations in static load.

According to a preferred embodiment, the function H is an affine function or a power function using the following formulae:

$$H = A * {Def}_{\%} + B ; or \qquad [ Math 10 a ]$$

$$H = X * {( {Def}_{\%} )}^{Y} ; \qquad [ Math 10 b ]$$

wherein (A, B) or (X, Y) are parameters related to the mounted assembly.

Depending on whether the aim is to evaluate the load Z applied to the mounted assembly under normal or particular conditions of use, the one or the other formula should be used for the function H. Indeed, in the conventional field of the use of a tyre casing applying the rules of the ETRTO (European Tyre and Rim Technical Technical Organization), a simple affine function correctly describes the evolution of the load Z as a function of the tyre casing deformation Def %. As a result, knowledge of the mounted assembly and in particular the tyre casing allows certain identification of the load Z applied to the mounted assembly. However, if the intention is to extend the field of modelling the load as a function of the tyre casing deformation for specific uses, such as for example very low or high loads Z, a power-type representation is more suitable. However, in the area of common usage, both functions yield results that are very similar and sufficient for the desired precision, less than 10%, preferably less than 5%.

According to a preferred embodiment, when the mounted assembly is inflated to the inflation pressure P, the parameters A or X are at least dependent on the inflation pressure P, preferably the parameters A or X are an affine function of the tyre pressure P according to the following formula:

$$A = {a}_{1} * P + {a}_{2} ; \qquad [ Math 11 a ]$$

$$X = {x}_{1} * P + {x}_{2} ; \qquad [ Math 11 b ]$$

wherein (a₁, a₂) or (x₁, X₂) are coefficients related to the mounted assembly.

According to a highly preferred embodiment, when the mounted assembly is inflated to the inflation pressure P, the parameters B or Y are at least dependent on the inflation pressure P, preferably the parameters B or Y are an affine function of the tyre pressure P according to the following formula:

$$B = {b}_{1} * P + {b}_{2} ; or \qquad [ Math 12 a ]$$

$$Y = {y}_{1} * P + {y}_{2} ; \qquad [ Math 12 b ]$$

wherein (b₁, b₂) or (y₁, y₂) are coefficients related to the mounted assembly.

Most tyre casings are mounted on a wheel and then inflated to an inflation pressure P that varies depending on the type of tyre casing. This inflation pressure P influences the mechanical behaviour of the mounted assembly and in particular that of the tyre casing. Consequently, the tyre casing deformation is influenced by this variable. Then this influence must be taken into account for coefficients A or X. It is the simplest representation of the dependency of the parameter A on the inflation pressure P that is realistic, in particular in the conventional field of use of a tyre casing according to the rules of the ETRTO.

The dependency on the inflation pressure P of these second parameters B or Y of the function His akin to an evolution of the gradient of the function H as a function of the tyre casing deformation Def %. This evolution of the gradient is less evident than the evolution of the stiffness of the tyre casing at the inflation pressure P as described by the first parameters A or X. However, this evolution of these second parameters B or Y with the inflation pressure P enhances the precision of the estimate of the load Z applied to the mounted assembly and therefore to the tyre casing.

Thus, at most 4 parameters a₁, a₂, b₁ and b₂ need to be identified, in the case of an affine function of the function H fully dependent on the inflation pressure P, in order to estimate the load Z applied to the mounted assembly. Of course, if the wheel is modified, the set of parameters needs to be readjusted in order to give a precise estimate. This set of parameters can also be identified through a digital simulation characterization or by experimental tests or by a mixture of the two.

### BRIEF DESCRIPTION OF THE DRAWINGS

The invention will be better understood upon reading the following description, which is provided solely by way of a non-limiting example and with reference to the accompanying figures, in which the same reference numbers in all cases designate identical parts and in which:

FIG. 1 shows an overview of the method according to the invention.

FIG. 2 shows an illustration of a first signal from a sensor.

FIG. 3 shows the angular resampling of the wheel-turn signal.

FIG. 4 shows an illustration of the resampled normalized wheel-turn signal.

FIG. 5 shows an illustration of the final signal after data aggregation over a sub-portion of the wheel-turn signal.

FIG. 6a is an illustration of evaluation of the energy densities S from the angularly resampled normalized wheel-turn signal.

FIG. 6b is an illustration of the spectral signal spect(Sig) of the wheel turn.

FIG. 7 is a representation of the estimate of the load Z applied to a mounted assembly in rolling condition.

### DETAILED DESCRIPTION OF EMBODIMENTS

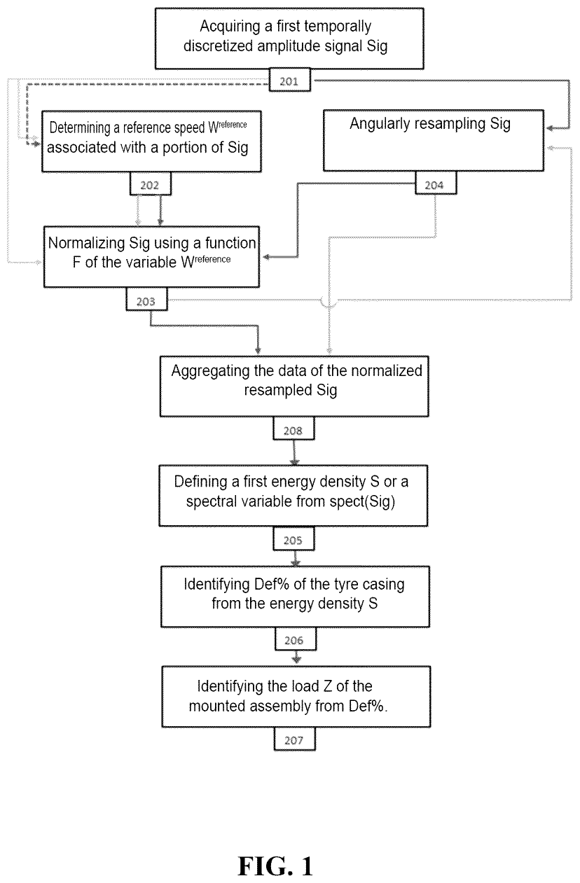

FIG. 1 shows an overview of the method according to the invention. From a first signal Sig obtained by temporal acquisition 201 of the amplitude output of an acceleration sensor during rolling of the tyre casing on which the sensor is mounted, a number of steps are performed following various possible pathways for obtaining a scalar representative of the load applied to the finally mounted assembly.

The first pathway comprises, from the temporal signal at the output of step 201, determining a reference speed W^{reference} 202 of the tyre casing in its mounted assembly configuration, i.e. tyre casing mounted on rim. Here, the first signal Sig 101 is already delimited over a certain number of wheel turns, 12 to be precise. Consequently, the first signal Sig 101 coincides with the wheel-turn signal Sig^{TDR}. This reference speed may be an angular speed linked to the natural rotation of the tyre casing around its rotational axis, but it may also be the translation speed per unit length of the tyre casing in the direction of travel thereof. This value may be determined from the wheel-turn signal Sig^{TDR} but also determined from another signal temporally in phase with the first signal and hence the wheel-turn signal Sig^{TDR}.

Then the wheel-turn signal Sig^{TDR} is normalized 203 from the first signal resulting from step 201 by a function F of the variable W^{reference} acquired in step 202. This function is the power function squared. After this step 203, a normalized signal is obtained for the movement of the tyre casing in a temporal description.

The normalized signal must then be angularly resampled in order to find a signal which is angularly periodic to the wheel turn through step 204. Then after this step 204, the result is a signal normalized and angularly resampled over several wheel turns.

The second pathway comprises, from the first signal Sig which is also the wheel-turn signal Sig^{TDR} resulting from step 201, angularly resampling the first signal Sig by phasing this first signal by means of the form of the first signal or by having another signal temporally phased with the first signal. The other signal comes from another sensor, or another track of the same sensor, such as the circumferential acceleration of a three-dimensional accelerometer. This angular resampling of the first signal leads to a signal periodic to the wheel turn at the end of step 204.

After having phased this angular signal using another temporal signal, a reference speed is determined from another temporal signal in phase with the first signal. Preferably, this is the same other signal which was used for angularly resampling the first signal in step 204. Thus a reference speed W^{reference} is identified at the end of step 202.

Then the reference speed allows normalizing of the angularly resampled signal from step 204 using a function of the reference speed variable. This gives an angularly resampled normalized wheel-turn signal Sig^{TDR} at the end of step 203.

Optionally, whichever pathway is taken, the data from the angularly resampled normalized wheel-turn signal Sig^{TDR} resulting from step 204 on the first pathway or step 203 on the second pathway are aggregated. This data aggregation in step 208 is carried out on a sub-portion of the input signal which is a multiple of a wheel turn, since the angularly resampled normalized signal is periodic to the wheel turn by its nature.

Alternatively, if the first signal 101 is polluted by known physical phenomena such as an accelerometer signal influenced by terrestrial gravity, it is sometimes useful—although not essential— to perform a correction of the first signal for this physical phenomenon in order to limit the parasitic noise generated by the physical phenomenon. This correction may take place at any step between step 201 and 204, but necessarily before the data aggregation step 205, which allows an improvement in the quality of the signal for tyre casing deformation. If correction takes place after the normalization step, the correction must also be normalized so as not to introduce a correction error.

Then in the first alternative, the method comprises a step of identifying 205 an energy density for the tyre casing deformation from the angularly resampled normalized wheel-turn signal. Although this may be performed on only a portion of the wheel turn through the positive energy density S⁺ or negative energy density S, it is preferable to take at least one complete wheel turn, which gives access to both said variables. Nor must it be forgotten to record the number of wheel turns N^{TDR} over the angularly resampled normalized wheel-turn signal Sig^{TDR}. If this signal is delimited over one wheel turn, identification of the energy densities is linked to the quality of the signal, which justifies using the optional step of data aggregation. However, if this signal is delimited over a large number of wheel turns, the signal may contain an additional fraction of a wheel turn which will only slightly modify the value of the energy density. In this case it would be preferable to count the wheel turns from the azimuthal position situated at 180 degrees from the centre of the contact patch. The additional fractions of a wheel turn will provide complementary points for the positive energy density S⁺, the variations of which between the points are smaller than during the contact patch entry and exit phases which have a greater effect on the negative energy density S⁻.

According to the second alternative, a spectral analysis 205 is performed on the normalized resampled wheel-turn signal in step 204 or 203 depending on pathway, this being periodic to the wheel turn. If the angular pitch is not regular, measurement points should be interpolated over the theoretical points regularly spaced over the signal. In some cases, the spectral analysis step 205 is carried out after a data aggregation step 207 which supplies a signal with a fixed angular pitch. The spectral signal resulting from step 205 is analysed to extract one or more spectral variables, preferably extracted from the first positive spectral block.

Then the method comprises a step 206 of identifying the tyre casing deformation in rolling condition under static load Def %. This is achieved using the energy density or densities S⁺, S⁻ evaluated in step 205 by means of a function G, or by using one or more spectral variables evaluated from a spectral signal spect(Sig) of the angularly resampled normalized wheel-turn signal Sig^{TDR}. Said spectral variable(s) will supply a function G, which in turn will provide a vector, preferably a scalar, as an invariant of the tyre casing deformation in rolling condition subjected to external forces.

Finally, in step 207, the method determines the load Z applied to the mounted assembly using a function H linking the load Z to the tyre casing deformation Def %. The fact that the tyre casing deformation is evaluated based on the response of a measurement signal that is potentially much larger than simply passing through the contact patch, as when the deformation Def^{%} is evaluated using the energy density S⁺, allows precision to be gained with respect to this deformation with a spatial discretization of the wheel-turn signal Sig^{TdR} that is much lower. This is less intensive in terms of energy and memory capacity, which allows this determination of the load Z to be carried out on the measurement device mounted on the tyre casing, such as a TMS (Tyre Monitoring Sensor). The spatial discretization of the method need not be as fine as that in the prior art, since the aim is not to identify the size of the contact patch.

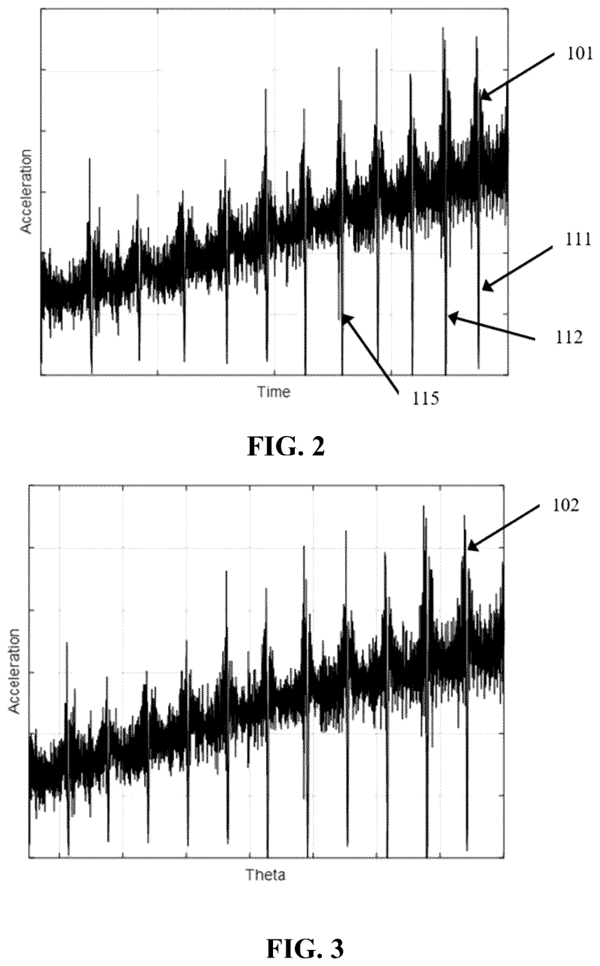

FIGS. 2 to 4 illustrate the method using the second pathway described in the overview of FIG. 1. The illustration is given for an accelerometer fixed at the crown of a tyre casing mounted on the inner liner of the tyre casing. Here, the tyre casing is a MICHELIN CrossClimate in size 265/65R17 under a static load of 800daN when mounted on a motor vehicle. The mounted assembly was inflated to 3 bar. Measurements were performed during travel of the vehicle on asphalt circuits with varying roughness, under standard conditions of speed and load applied according to the tyre marking. The mounted assembly was situated on the front axle of the vehicle. The measurements here were performed mostly in straight-line travel.

FIG. 2 shows a temporal signal 101 acquired with a signal acquisition frequency of 3200 Hz, allowing very fine discretization of the signal. This therefore records all variations in acceleration at the crown of the tyre casing during rolling. This was delimited over 12 wheel turns in order to constitute the wheel-turn signal Sig^{TDR}.

The recording in FIG. 2 was performed in an acceleration phase of the vehicle, which is reflected by an increase in the amplitude of the accelerometric signal. The sensor here is a single-axis accelerometer mounted radially relative to the crown of the tyre casing, before creation of the mounted assembly by conventional fixing techniques known in the prior art. The data were transmitted by wireless communication between an electronic device galvanically connected to the accelerometer and a second radiofrequency device placed in the vehicle. In this particular case, the post-processing of the measurements was performed in the vehicle. However, it is quite possible to perform these in a first electronic device connected to the sensor, equipped with a microcontroller or microprocessor and coupled to sufficient memory space to perform the elementary mathematical operations required by the method.

Here, the first step consists of determining the reference speed, taking as reference speed the angular rotation speed. For this, the first temporal signal 101 must be phased with a reference azimuthal position of the wheel turn. To this end, the first signal 101 shows regular quite strong falls in amplitude 111, 112 which reflect the passage through the contact patch of the angular sector carrying the accelerometer. Naturally, these downward and upward slopes of the falls 111, 112 represent respectively the entry and exit of the contact patch. The centre of the contact patch is the middle of the interval separating the entry and exit of the contact patch. This centre is assigned the azimuthal position of 0 degrees which will be our azimuthal reference. By taking a second angular reference on the next signal fall 112 for example, the signal 101 is determined for a wheel turn of 360 degrees and a temporal interval associated with this wheel turn. The reference speed W^{reference} is defined as the ratio of angular variation between the two centres of the contact patch to the temporal interval separating these two azimuthal positions. This reference speed W^{reference} is assigned to the portion of the signal situated between these two centres of the contact area. Naturally, two non-contiguous falls 111, 115 of the temporal signal 101 could be considered for determining a second reference speed W^{reference} and assigning the second speed to the portion of the signal 101 situated between the two falls 111, 115.

FIG. 3 shows the result of the step of angular resampling of the temporal signal 101. Thus, using the determination of the centres of the contact patch for each fall in temporal signal performed in the preceding step, it is easy to phase the temporal signal with the wheel turn over 360 degrees. Then the discretized measurement points are linearly distributed over the wheel turn. Even if an angular positioning error is made at this step, a linear interpolation performed for example during the data aggregation step will smooth out the results and minimize the angular positioning error. In a more sophisticated fashion, a reference speed is evaluated on each wheel turn. It is possible to assign evolving angular speeds to the wheel turn by taking into account reference speeds of contiguous turns. For example, having determined the reference speeds over three consecutive turns, it is possible to assign to the central wheel turn a first reference speed for the first quarter wheel turn, being the barycentric speed of the reference speed of the preceding weighted turn 2 and the reference speed of the current weighted turn 1. The following quarter will have a reference speed being the barycentric speed of the reference speed of the current weighted turn 2 and the reference speed of the preceding weighted turn 1. The third quarter wheel turn will have a reference speed being the barycentric speed of the reference speed of the current weighted turn 2 and the reference speed of the next weighted turn 1. Finally, the last quarter wheel turn will have a reference speed being the barycentric speed of the reference speed of the current weighted turn 1 and the reference speed of the next weighted turn 2. All discretized measurement points are distributed over each quarter wheel turn in proportion to the ratio of reference speeds of each quarter turn to the reference speed of the current turn. Other methods for smoothing the points may also be applied. Here, the spatial discretization of points is not regular because of the variable rolling speed. It is quite possible to make this discretization of points of signal 102 regular by applying a method of interpolating measurement points over a given angular distribution for the wheel turn. This then provides an angularly resampled signal 102 with a regular angular pitch. FIG. 3 shows the angularly resampled signal 102 which is periodic to the wheel turn with arbitrary discretization of measurement points.

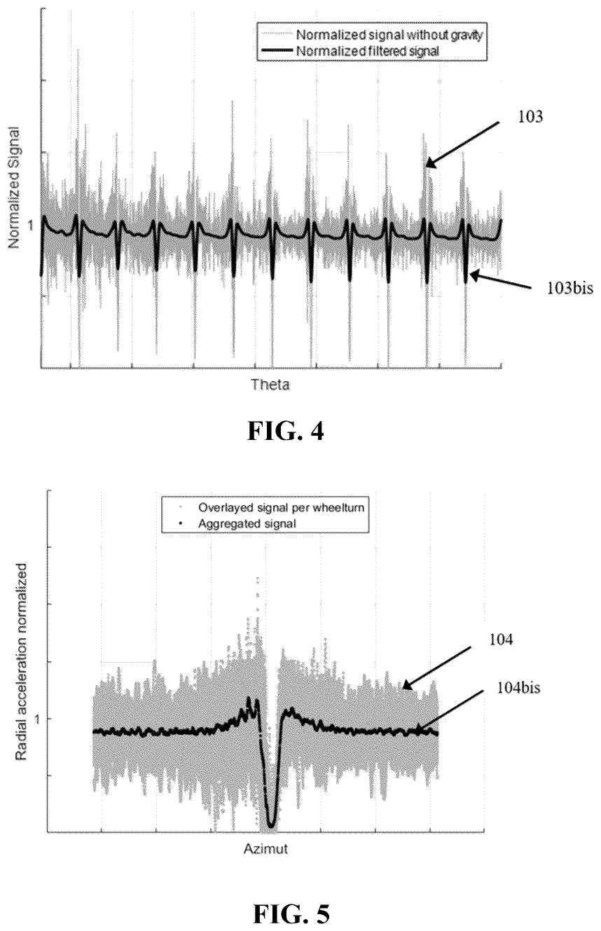

FIG. 4 shows the result of the step of normalizing the first angularly resampled signal 102 without interpolation of points. Thus, using the periodicity to the wheel turn of the angularly resampled wheel-turn signal, it is easy to break down the angular signal over a wheel turn or over a multiple of the wheel turn as illustrated in FIG. 4, here 12 wheel turns. The normalization step consists of dividing the amplitude of the signal by the power function squared of the reference speed associated with each portion of a wheel turn. The reference speed was determined during the first signal processing step 101 for example. The reference speed is here an angular speed. The result observed on curves 103 and 103bis is that the amplitude of the normalized signal is similar for each wheel turn. We no longer see the strong variations in amplitude between the various wheel turns performed at difference speeds and on different roads. Also, the signal is centred on the unit value. Then the wheel turn segments are superposed over the same angular interval of a length which is an integral multiple of 360 degrees, as shown by the grey curves which here form a curve bundle 103. This takes into account the spread of measurements between wheel turns, which is accentuated by the fact that here the signals have not been corrected for terrestrial gravity. However, if a low-pass filter is applied, we obtain black curve 103bis which is smoother since cleaned of certain parasitic noise. This allows us to see that signal 103bis is periodic to the wheel turn with slight variations between wheel turns. At the end of this normalization of signal 102, we obtain an angularly resampled normalized signal 103. FIG. 4 shows the angularly resampled normalized signal 103 which is centred on the unit value, as confirmed by the filter applied to curve 103bis.

FIG. 5 is the result of the step of aggregation of the data from signal 103 from the preceding step, which is an optional step. Here, the segments of each wheel turn are superposed over the same angular interval of a length of 360 degrees, as shown by the grey curves which here form a curve bundle 104. This takes into account the spread of measurements between each wheel turn, which is accentuated by the fact that the signals have not been corrected for terrestrial gravity. However, if we apply a correction for terrestrial gravity to each wheel turn before the normalization step, since the accelerometer is here sensitive to terrestrial gravity, data aggregation by a method of the mean over a decile interval determines the curve 104bis, which is much more stable for the wheel turn. This gives a signal for tyre casing deformation subjected to external forces, in particular the static load in this case. This signal 104bis is representative of the measurement of the tyre casing in rolling condition at variable speed on ground of any roughness. This curve is an invariant of the tyre casing in rolling condition under static load in a state mounted on the rim.

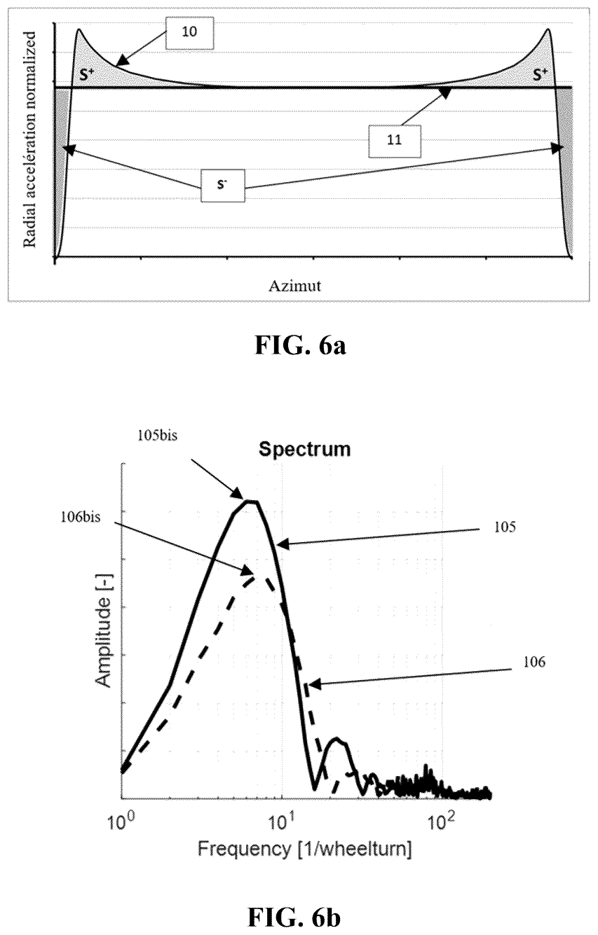

FIG. 6a is an illustration to explain the computation of the positive S⁺ and negative S⁻ energy densities on an angularly resampled normalized wheel-turn signal Sig^{TDR} corresponding to a single wheel turn. Naturally, the method is identical if the angularly resampled normalized wheel-turn signal Sig^{TDR} is delimited over several wheel turns.

The threshold A is determined as being the unit value here. This threshold is shown by the solid line 11. In fact, adopting a value equal to 0.7 is preferable on real signals. If there is a lot of interference on the signals, then a value equal to 0.5 or 0.6 may be chosen. However, for signals obtained on generally smooth road surfaces, a value of the order of 0.8 or 0.9 can be used. This value of threshold A must be set for all the steps of the method.

The positive S⁺ or negative S⁻ energy densities are calculated as the sum of the absolute values of the differences between the wheel-turn signal 10 and the unit value represented by the continuous curve 11. Necessarily, the area delimited by the areas S⁺ is equal to the area delimited by the area S⁻.

From the estimate of these energy densities S, it is easy to determine the tyre casing deformation Def % subjected to a static load in rolling condition.

FIG. 6b shows the spectrum of the angularly resampled normalized wheel-turn signal with a fixed angular pitch of 0.1 degrees which was delimited over 12 wheel turns. In order to limit the high-frequency phenomena, the signal resulting from step 203 in the first pathway or step 204 in the second pathway was first filtered using a low-pass filter of one thirtieth of the wheel turn.

The filtered signal, or here the signal from the aggregation step in step 208, was then spectrally analysed using a Fourier transformation before obtaining curve 105, which represents the amplitude of the Fourier transformation over a limited frequency band. This curve shows various spectral blocks, a first of which has great amplitude. However, the following blocks are themselves not negligible.

It is possible to obtain multiple spectral variables from this spectral response 105. In this case we will focus on the first block, but analysis may also take place on the following blocks.

In order to take account of the sensitivity of the method, FIG. 6b shows a second dotted curve 106 which corresponds to the spectral response of the same sensor fixed to the same mounted assembly, for a different static load and a different inflation pressure, wherein the mounted assembly has been swapped between the front and rear axles of the vehicle. Thus necessarily, the mechanical response of the tyre casing to its two variables, inflation pressure and static load, is different. However, the spectral response shows a similarity in terms of form by a response in the form of successive blocks, the width and height of which are a function of external forces applied to the tyre casing.

From this, we find that analysis of the first block is sufficiently discriminating to determine the tyre casing deformation following these variations in external forces, although may not be sufficient for weaker variations in external forces applied to the tyre casing.

The spectral variables such as the maximum value, median value, mean value, pass band, area below the curve associated with the first block, are all potential criteria for differentiation of the tyre casing deformation. But also the frequency of the median value, the frequency of the mean value and the frequency of the maximum value are secondary criteria in the tyre casing deformation which show a much weaker although still discriminating dynamic.

We can then assign a tyre casing deformation value Def % by means of a function of one or more spectral variables in the form of a vector or scalar, which may in some cases serve as weighting for the various components of the vector. Preferably, it is found that the maximum value 105bis and 106bis of the first block is a very good indicator of the tyre casing deformation, which allows determination of the tyre casing deformation through an affine function of the maximum value of the first block. However, determination of the tyre casing deformation may become more sophisticated if other spectral variables, also linked to secondary spectral blocks, are taken into account.

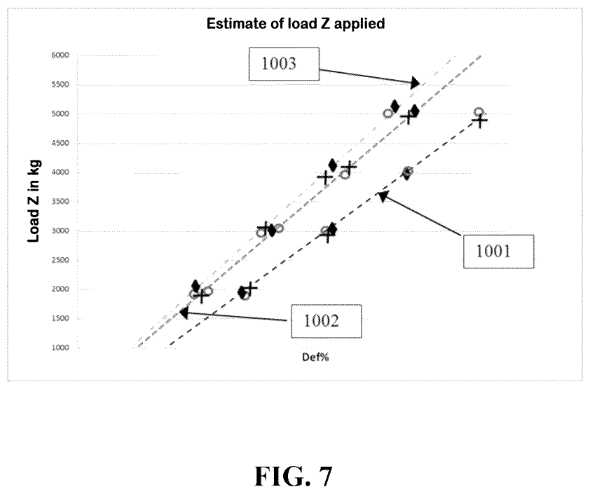

FIG. 7 is an illustration of the estimate of the load Z applied to a mounted assembly in rolling condition at a rotation speed W. Here, two different casings were used. The first E1 is a 385/55R22.5 Michelin heavy goods vehicle tyre casing from the X Multiway T range with a wear level D1 mounted on a 22.5 inch plate wheel. The second tyre casing E2 is a Michelin 315/80R22.5 from the X Multiway 3D XDE range with a wear level D2. Each casing is equipped with an on-board electronic device comprising a mono-axis accelerometer positioned at the crown on the inner liner at the level of a protruding sculpture element, i.e. different from a longitudinal groove. The acquisition frequency of the accelerometer is 1200 Hz.

Each tyre casing undergoes a series of rolling scenarios in which the speed of movement is varied around 20, 40 and 60 km/h at an inflation pressure P varying from 7 to 9 bars in increments of 1 bar. The pressure is measured during rolling by means of a pressure sensor, in this instance integrated into a TPMS mounted on the wheel valve. Finally, the load Z applied to the mounted assembly varies between 2000 and 5000 kg in increments of 1 tonne.

The four coefficients (a₁, a₂, b₁, b₂) of the affine functions of the function H of each tyre casing were determined in advance, using the digital simulation. Indeed, since this is exactly the area of use recommended by the rules of the ETRTO, the affine representation of the function H must be preferred.

Half the rolling scenarios were carried out at a constant rotation speed, while the other half were carried out at a variable rotation speed around the target speed at +/−15%.

FIG. 7 shows continuous straight lines corresponding to the response provided by the coefficients of the function H, which in this instance depend on the inflation pressure P and the mounted assembly, including the tyre casing. Different shapes of symbols are also noted depending on the target rolling speed, diamonds for speeds at 20 km/h, circles for speeds at 40 km/h and crosses for speeds at 60 km/h.

The curve 1001 corresponds to the mounted assembly comprising the tyre casing E1 at an inflation pressure of 7 bar. The curve 1002 corresponds to the mounted assembly comprising the tyre casing E2 at the inflation pressure of 8 bar. Finally, the curve 1003 corresponds to the mounted assembly, the tyre casing of which is E1 at the inflation pressure of 9 bar.

A relatively good correlation can be seen between the estimate of the load Z with the true applied load, irrespective of the speed of movement and inflation pressure. In addition, depending on the nature of the tyre casing, the affine representation of the load is realistic relative to the tests in this range of conditions of use of the mounted assembly.

Equally good results are obtained irrespective of the nature of the tyre casing, the applied load, the inflation pressure used and the wear of the tyre.

1.-15. (canceled)

16. A method for ascertaining a load applied to a tire casing when mounted on a wheel so as to constitute a pneumatic mounted assembly in rolling state with rotation speed W, the tire casing having a crown in contact with a ground and in revolution about a natural rotational axis, the method comprising the following steps:
fastening at least one sensor to the tire casing at the crown of the tire casing so as to generate at least one output signal sensitive to acceleration, in a direction normal to the crown, applied to the sensor in the tire casing;
acquiring at least one first temporal signal Sig comprising at least an amplitude of the at least one output signal while rolling;
delimiting the first signal Sig over a number N^{TdR} of wheel turns so as to construct a wheel-turn signal Sig^{TdR}, wherein N^{TdR} is greater than 1;
determining at least one reference speed W^{reference} associated with at least one portion of the wheel-turn signal Sig^{TdR},
normalizing the at least one portion of the wheel-turn signal Sig^{TdR} by a variable which is a function F proportional to a square of the reference speed W^{reference}, over a number of wheel turns N^{TdR}, wherein N^{TdR} is greater than or equal to 1;
angularly resampling the at least one portion of the wheel-turn signal Sig^{TDR};
defining at least one energy density S from the at least one angularly resampled normalized wheel-turn signal Sig^{TDR}, by means of a threshold A or, if an angular pitch is fixed, at least one spectral variable from a spectral signal spect(Sig) of the at least one portion of the angularly resampled normalized wheel-turn signal Sig^{TDR};
identifying a deformation Def % of the tire casing as a function G of the at least one first energy density S or the at least one spectral variable; and
defining a load Z applied to the mounted assembly by means of a bijective function H comprising at least, as a variable, the deformation Def % of the tire casing.

17. The method for ascertaining the load applied to a tire casing according to claim 16, wherein the step of determining the reference speed W^{reference} consists of establishing a ratio of an angular variation to a temporal duration separating two azimuthal positions of the at least one sensor in the tire casing around the natural rotational axis, from the first signal Sig or from a signal in phase with the first signal Sig, according to the following formula:
$${W}^{Reference} = \frac{Δ ( α )}{Δ ( t )} , \qquad [ Math 1 ]$$
wherein a is an angular position and t is a temporal abscissa associated with the angular position.

18. The method for ascertaining the load applied to a tire casing according to claim 16, wherein the angular pitch is less than 18 degrees.

19. The method for ascertaining the load applied to a tire casing according to claim 16, further comprising a step of aggregating data from the at least one portion of the angularly resampled normalized wheel-turn signal Sig^{TDR} over at least one sub-portion of the at least one portion of the angularly resampled normalized wheel-turn signal Sig^{TDR}, the at least one sub-portion of the at least one portion of the angularly resampled normalized wheel-turn signal Sig^{TDR} becoming the at least one portion of the angularly resampled normalized wheel-turn signal Sig^{TDR}.

20. The method for ascertaining the load applied to a tire casing according to claim 19, wherein the at least one sub-portion of the at least one portion of the wheel-turn signal Sig^{TDR} is an integral multiple of the wheel turn.

21. The method for ascertaining the load applied to a tire casing according to claim 16, wherein having phased the first signal Sig with respect to an angular position of the tire casing, a correction Corr is made to the first signal Sig to take account of an effect of terrestrial gravity before the normalization step.

22. The method for ascertaining the load applied to a tire casing according to claim 16, further comprising a step of filtering the at least one portion of the angularly resampled normalized wheel-turn signal Sig^{TDR}.

23. The method for ascertaining the load applied to a tire casing according to claim 16, wherein the step of acquiring the at least one spectral variable from a spectral signal spect(Sig) of the at least one portion of the angularly resampled normalized wheel-turn signal Sig^{TDR} consists of identifying the at least one spectral variable over at least one spectral block of the spectral signal spect(Sig).

24. The method for ascertaining the load applied to a tire casing according to claim 23, wherein the at least one identified spectral variable is contained in the group consisting of a maximum value, a median value, a mean value, a pass-band of a first block, an area below a curve of the first block, a frequency of the median value, a frequency of the mean value, and a frequency of the maximum value.

25. The method for ascertaining the load applied to a tire casing according to claim 16, wherein the step of obtaining the at least one energy density S from the at least one portion of the angularly resampled normalized wheel-turn signal Sig^{TDR} by means of a threshold A consists of defining a first energy density S⁺ when the at least one portion of the angularly resampled normalized wheel-turn signal Sig^{TDR} is greater than the threshold A, or defining a second energy density S⁻ when the at least one portion of the angularly resampled normalized wheel-turn signal Sig^{TDR} is less than or equal to the threshold A.

26. The method for ascertaining the load applied to a tire casing according to claim 10, wherein the threshold A is between 0.5 and 0.9.

27. The method for ascertaining the load applied to a tire casing according to claim 16, wherein the function G is a linear function.

28. The method for ascertaining the load applied to a tire casing according to claim 16, wherein the function His an affine function or a power function according to the following formulae:
$$H = A * {Def}_{\%} + B ; or \qquad [ Math 10 a ]$$
$$H = X * {( {Def}_{\%} )}^{Y} ; \qquad [ Math 10 b ]$$
wherein (A, B) or (X, Y) are parameters related to the mounted assembly.

29. The method for ascertaining a load applied to a tire casing according to claim 28, wherein, when the mounted assembly is inflated to an inflation pressure P, the parameters A or X are at least dependent on the inflation pressure P.

30. The method for ascertaining a load applied to a tire casing according to claim 28, wherein, when the mounted assembly is inflated to an inflation pressure P, the parameters B or Y are at least dependent on the inflation pressure P.
